(19) United States
(12) Patent Application Publication
(10) Pub. No.: US 2011/0063533 A1
(43) Pub. Date: Mar. 17, 2011

(54) METHOD OF DISPLAYING STEREOSCOPIC IMAGES MIXED WITH MONOSCOPIC IMAGES AND MONO/STEREOSCOPIC IMAGE DISPLAY APPARATUS CAPABLE OF PERFORMING THE METHOD

(76) Inventors: Hwi KIM, Seoul (KR); Hae-Young Yun, Gyeonggi-do (KR); Jian-Gang Lu, Gyeonggi-do (KR); Kyung-Ho Jung, Gyeonggi-do (KR); Seung-Hoon Lee, Gyeonggi-do (KR); Jung-Hwan Yi, Seoul (KR); Hee-Seop Kim, Gyeonggi-do (KR)

(21) Appl. No.: 12/773,683

(22) Filed: May 4, 2010

(30) Foreign Application Priority Data
Sep. 17, 2009 (KR) 2009-0087832

(51) Int. Cl. H04N 13/04; G06T 15/00; G02F 1/1335

(52) U.S. Cl. 349/15; 345/419

(57) ABSTRACT

An image display apparatus is provided that can display one or both of 2D imagery and 3D imagery in respective but randomly selectable display areas of the apparatus. The apparatus a display panel, a driving circuit part, a polarization switch panel and a lens. The driving circuit part processes received frame image data representing two-dimensional (2D) imagery and three-dimensional (3D) imagery to thus provide the display panel with the processed frame image. The polarization switch panel is disposed above the display panel. The polarization switch panel is switched into a first polarization mode in correspondence with 2D imagery being displayed by the display panel and it is switched into a second polarization mode in correspondence with 3D imagery being displayed by the display panel. The lens is reacts differently to light rays having the effect of the first polarization mode imparted to them and to light rays having the effect of the second polarization mode imparted to them. More specifically, the lens strongly refracts light rays that are imparted with the second polarization mode (3D imagery light) and weakly or not at all refracts light rays that are imparted with the first polarization mode (2D imagery light). Thus, both the 2D image and the 3D image may be displayed on one screen.

### PRIORITY STATEMENT

This application claims priority under 35 U.S.C. §119 to Korean Patent Application No. 2009-87832, filed on Sep. 17, 2009 in the Korean Intellectual Property Office (KIPO), the contents of which application are herein incorporated by reference in their entirety.

### BACKGROUND 1. Field of Disclosure

Example embodiments in accordance with the present disclosure relate to a method of displaying a stereoscopic image and a stereoscopic image display apparatus for performing the method. More particularly, example embodiments illustrated herein relate to a method capable of displaying both two-dimensional (2D) monoscopic images and three-dimensional (3D) stereoscopic images in a same one continuous screen area and a mono/stereoscopic image display apparatus capable of performing the method.

2. Description of Related Technology

Recently, as more and more three-dimensional (3D) movies (e.g., James Cameron's “Avatar”™) are being widely supplied in the movie industry, the demand for at-home provision of 3D stereoscopic images is expected to increase in the over-the-internet or DVD supported entertainment field and in the advertisements providing field as well as in other personalized information supplying fields.

Since demands for provision of 3D stereoscopic images are expected to increase but at the same time legacy 2D imagery is expected to remain, companies related to the stereoscopic imaging field are focusing on display apparatus that will be capable of switching between displaying of a legacy 2D image and also a newer 3D image, so as to thereby provide a single display apparatus capable of displaying either a 2D image or a 3D image or both at substantially the same time.

That is, a 2D image or a 3D image format may be selected by the user of a display apparatus or by the content provider, where the apparatus is expected to be capable of being selectively switched between a 2D imaging mode and a 3D imaging mode across its entire screen area or in selected subareas of the screen. Accordingly techniques by which a 2D image or a 3D image is displayed on one screen have to be developed or improved upon.

However, practical techniques which enable one screen area to simultaneously display both a 3D image and a 2D image are not believed to have yet been developed.

In one approach, a 3D image is displayed on a specific, specially structured, dedicated and discontinuous portion of one screen and a 2D image is displayed on a remaining and otherwise continuous portion of the same screen, so that an interactive system such as advertisement, haptic, a touch screen sensor (i.e., an infrared ray panel sensor), etc., may be used in various industry fields. However, in this dedicated area approach, both of the 2D and 3D imagery cannot be alternately provided in a same screen area nor can they have their respective positions of display on the screen swapped.

### SUMMARY

Example embodiments in accordance with the present disclosure of invention provide a method of alternatingly displaying in a same screen area, a two-dimensional (2D) image and a three-dimensional (3D) image.

Example embodiments illustrated herein also provide a mono/stereoscopic image display apparatus for performing the above-mentioned method.

According to one aspect of the present disclosure, there is provided a method of selectively displaying a stereoscopic image and a monoscopic image. In the method, 2D frame image data and 3D frame image data are provided, identified as such and designated for respective scaled display in randomly selectable parts of the screen. The identified 2D frame image data is separated from the identified 3D frame image data and each is respectively rendered in appropriately scaled size and position as generally non-black imagery on an otherwise black-filled and respective background. The so rendered frames of the 2D frame image data on its black-filled background and the 3D frame image data on its respective black-filled background are alternatingly flash displayed (output as strobed frames) on a high speed flat panel. Above the strobed display panel there are provided a polarization changing layer and a polarization sensitive refracting layer, where the polarization changing layer is interposed between the strobed display panel and the polarization sensitive refracting layer. The polarization sensitive refracting layer refracts light rays sent through or does not refract those light rays depending on their respective polarizations. The polarization changing layer is electronically controllable to selectively impart one of first and second polarization effects on light rays passing through it. The polarization changing layer is electronically controlled in synchronism with the strobed output of the rendered-on-black 2D frame imagery and the strobed output of the rendered-on-black 3D frame imagery so as to thereby impart a first polarization effect on light rays of the 2D frame imagery and a second polarization effect on light rays of the 3D frame imagery. More specifically and in one embodiment, the polarization sensitive refracting layer does not refract light rays of the 2D frame imagery that have the first polarization effect imparted to them and it does refract light rays of the 3D frame imagery that have the second polarization effect imparted to them. In one embodiment, the polarization sensitive refracting layer comprises one or more lenticular lenses having optical characteristics for generating a stereoscopic image.

According to another aspect of the present disclosure, there is provided a method of displaying a mono/stereoscopic image. In the method, alternating frames of imagery, including a first image frame containing only 2D imagery and a second image frame containing only 3D imagery are displayed on a display panel. A first light polarization effect is selectively imparted by a first area of a controlled polarization switch panel to light rays belonging to the 2D imagery, and a second light polarization effect is selectively imparted by a second area of the polarization switch panel corresponding to the light rays belonging to the 3D imagery. The light rays which have the first polarization effect applied to them are output as linear (substantially non-refracted) light rays from the polarization sensitive refracting layer, whereas the light rays which have the second polarization effect applied to them are output as bent (substantially refracted) light rays from the polarization sensitive refracting layer. The bent light rays are used to create a perception of a corresponding stereoscopic image. On the other hand, the non-bent (non-refracted) light rays are used to create a perception of a corresponding monoscopic image.

According to another aspect of the present disclosure, a combined mono/stereoscopic image displaying apparatus includes a display panel, a driving circuit part, a polarization switch panel and a polarization sensitive lens. The display panel displays an image. The driving circuit part processes received frame image data comprising an image data for 2D and an image data for 3D. The processing may include segregating the respective 2D and 3D image portions, scaling and/o re-positioning each (or not) as deemed appropriate and respectively rendering each on an otherwise black-filled and respective background. The rendered image frames are then provided to the display panel for alternate display at high speed by the display panel. The polarization switch panel is disposed above the display panel. A polarization sensitive refraction layer is disposed above the polarization switch panel. The polarization switch panel is switched into a first polarization effect imparting mode in timed correspondence with display of the 2D image content and it is switched into a second polarization effect imparting mode in timed correspondence with display of the 3D image content. The polarization sensitive refraction layer (e.g., lens) transmits light rays having the first polarization effect substantially without refracting the light rays and transmits light rays having the second polarization effect while refracting those light rays. The refracted light rays correspond to the image for 3D.

In an example embodiment, the driving circuit part may generate a 2D frame image data comprising a 2D image data and a first black background-filling image data and a 3D frame image data comprising a 3D image data and a second black background-filling image data by using the originally provided frame image data, and provide the display panel with the rendered 2D frame image data and the rendered 3D frame image data, respectively.

In an example embodiment, the polarization switch panel is switched into the first polarization mode for firstly polarizing the structure 2D frame image according to a first polarization axis when the structure 2D frame image is being displayed, and it s switched into the second polarization mode for secondly polarization the rendered 3D frame image according to a second polarization axis when the rendered 3D frame image is being displayed on the display panel.

In an example embodiment, the driving circuit part includes a data driving part, a scaler and a timing control part. The data dividing part may divide (partition) frame image data received at a first frame frequency (first number of frames per second) into separate 2D image data and 3D image data. The scaler may generate the 2D image frame data as appropriately scaled (resized) 2D image data and may render the scaled 2D image data on an otherwise black-filled first background. The scaler may generate the 3D image frame data as appropriately scaled (resized) 3D image data and may render the scaled 3D image data on an otherwise black-filled second background. The timing control part may alternately output the rendered 2D frame image data and the rendered 3D frame image data at a second frame frequency that is higher than the first frame frequency.

In an example embodiment, the second frame frequency may be about 120 Hz or about 240 Hz.

In an example embodiment, the driving circuit part may drive a first area of the polarization switch panel into the first polarization mode in correspondence with 2D image data being output from that first area, and may drive a second area of the polarization switch panel into the second polarization mode in correspondence with 3D image data being output from that second area.

In an example embodiment, the polarization switch panel may transmit a first polarization light of the first area and transmits a second polarization light of the second area.

In an example embodiment, the driving circuit part may include a data driving part and a timing control part. The data dividing part may divide the frame image data received in a first frame frequency into the 2D image data and the 3D image data. The timing control part may output the frame image data to the display panel.

In an example embodiment, the driving circuit part may further include a polarization panel controller being driven into the first polarization mode when 2D image data is being passed there through and being driven into the second polarization mode when 3D image data is being passed there through.

In an example embodiment, a first polarization axis of the first polarization mode may be substantially perpendicular to a second polarization axis of the second polarization mode.

According to a method of displaying a stereoscopic image and a stereoscopic image display apparatus for performing the method, a polarization switch panel is operated in a first polarization mode when a 2D image is provided from a display panel and is operated in a second polarization mode when a 3D image is provided from the display panel, so that the 2D image and the 3D image may be displayed on one screen.

Moreover, in one embodiment, the polarization switch panel includes a first area which can be independently operated in the first polarization mode corresponding to the 2D image while a second area is independently operated in the second polarization mode corresponding to the 3D image, so that the 2D image and the 3D image may be displayed on one screen.

### BRIEF DESCRIPTION OF THE DRAWINGS

The above and other features and advantages of the present disclosure will become more apparent by describing in detailed example embodiments thereof with reference to the accompanying drawings, in which:

FIG. 1 is a perspective view schematically illustrating an example of a mono/stereoscopic image display apparatus according to a first Embodiment (#1) of the present disclosure;

FIG. 2A is a cross-sectional view of the liquid crystal lens of FIG. 1;

FIG. 2B is a graph showing a refractive index of the liquid crystal lens of FIG. 2A varying as a function of position and voltage;

FIG. 3 is a block diagram schematically illustrating a mono/stereoscopic image display apparatus according to the first embodiment;

FIG. 4 is an image schematically showing an example of a two-dimensional (2D) image rendered on a respective black-filled background;

FIG. 5A is an image schematically showing an example of a three-dimensional (3D) image rendered on a respective black-filled background;

FIG. 5B is a timing diagram illustrating alternating flashed display of the rendered images of FIGS. 4 and 5A;

FIG. 6 is a cross-sectional view schematically showing light rays of a 2D image that have a first polarization effect imparted to them by the polarization switch panel of FIG. 1 and thus exiting the lens layer without substantial refraction;

FIG. 7 is a cross-sectional view schematically showing light rays of a 3D image that have a second polarization effect imparted to them by the polarization switch panel of FIG. 1 and thus exiting the lens layer with substantial refraction (e.g., bending) imparted to them;

FIG. 8 is an image schematically showing an example of how a mono/stereoscopic image is perceived when the 2D image of FIG. 4 and the 3D image of FIG. 5A are driven in a high speed and the polarization switch is switched into 2D or 3D mode in synchronism with the 2D and 3D image frames respectively;

FIG. 9 is a flowchart showing a method of displaying a mono/stereoscopic image according to Embodiment 1;

FIG. 10 is a perspective view schematically illustrating another example of a stereoscopic image display apparatus according to the present disclosure;

FIG. 11 is a perspective view schematically illustrating a mono/stereoscopic image display apparatus according to a third embodiment;

FIG. 12 is a block diagram schematically illustrating a stereoscopic image display apparatus according to the third embodiment; and

FIG. 13 is a flowchart showing a method of displaying a stereoscopic image in accordance with Embodiment 3.

### DETAILED DESCRIPTION

The present disclosure of invention is described more fully hereinafter with reference to the accompanying drawings, in which example embodiments are shown. The present teachings may, however, be embodied in many different forms and should not be construed as limited to the example embodiments set forth herein. Rather, these example embodiments are provided so that this disclosure will be thorough and complete, and will fully convey the scope of the present teachings to those skilled in the pertinent art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present disclosure.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present teachings. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures) of the present invention. As such, variations from the shapes of the illustrations as a result, for example, of manufacturing techniques and/or tolerances, are to be expected. Thus, example embodiments of the present disclosure should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which the claimed subject matter most closely pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present disclosure of invention will be explained in detail with reference to the accompanying drawings.

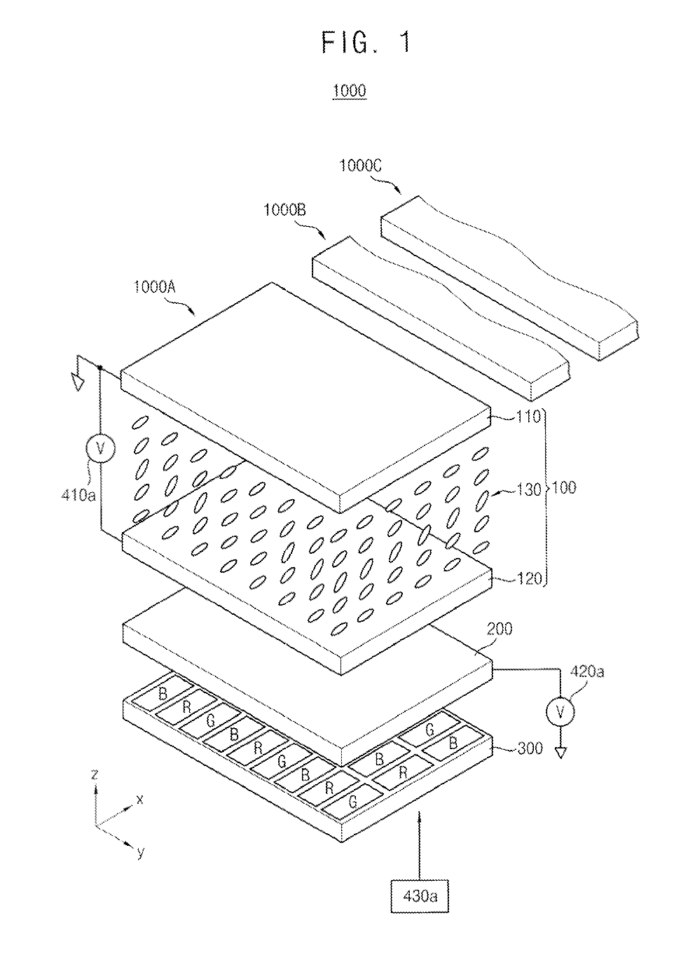

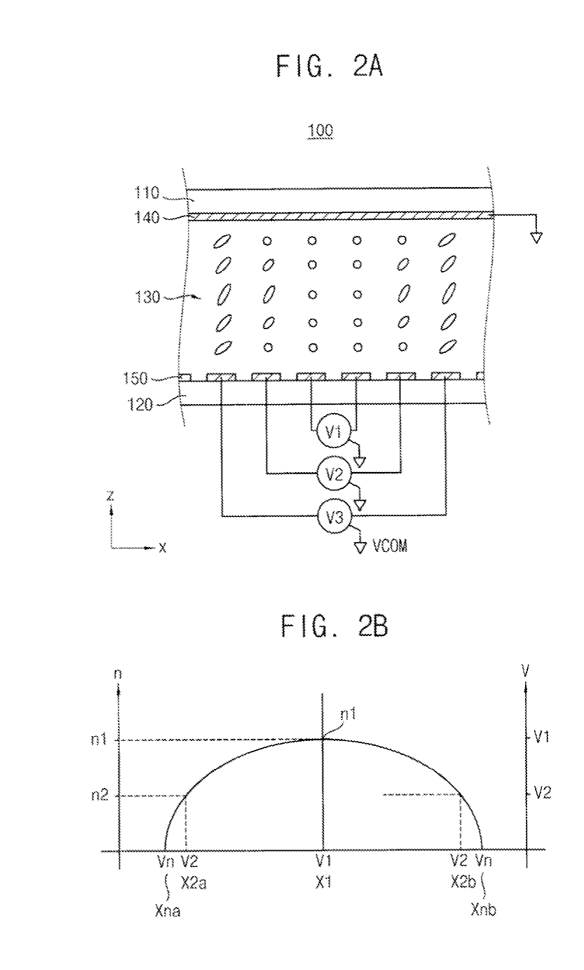

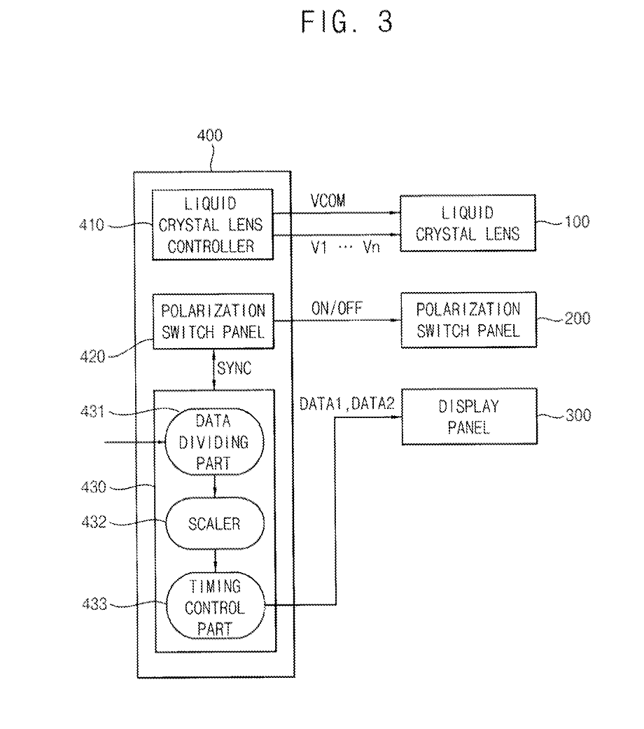

FIG. 1 is a perspective view schematically illustrating an example of a first stereoscopic image display apparatus 1000 (Embodiment 1) in accordance with the disclosure. FIG. 2A is a cross-sectional view of an electronically controllable liquid crystal lens (LCL) 100 provided in FIG. 1. FIG. 2B is a graph showing a refractive index of the LCL 100 of FIG. 2A. FIG. 3 is a block diagram schematically illustrating a stereoscopic image display apparatus 1000 according to the present embodiment.

Referring to FIGS. 1, 2A, 2B and 3, a mono/stereoscopic image display apparatus 1000 according to the present embodiment includes a plurality of replicated side-by-side sections, 1000A, 1000B, 1000C, etc. where just section 1000A is shown in more detail. As seen, section 1000A includes an electronically controllable LCL such as the one shown at 100, an electronically controllable polarization switch panel section 200 and a flat image display panel section 300. In addition, the stereoscopic image display apparatus 1000 further includes a driving circuit part 400 (FIG. 3). In one embodiment, the flat image display panel section 300 is part of a backlit Liquid Crystal Display (LCD) panel that outputs linearly pre-polarized light to the electronically controllable polarization switch panel 200 due to presence of polarization sheets below and above a liquid crystal layer (not shown) of the LCD panel.

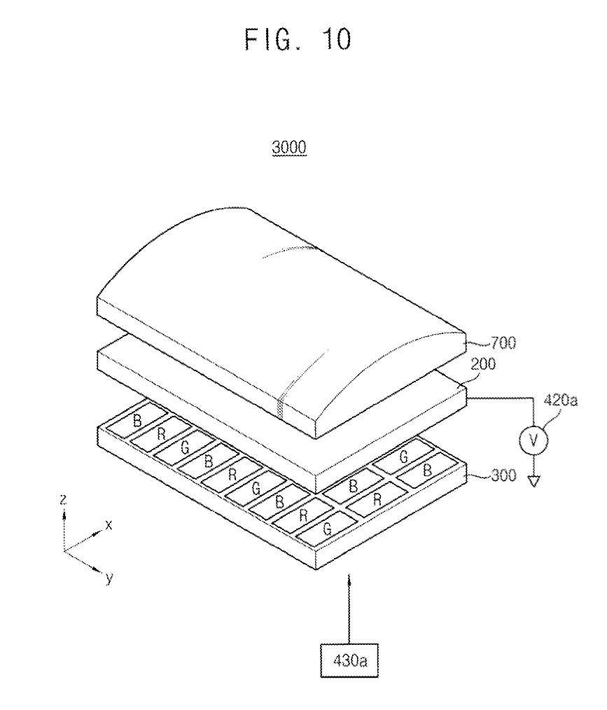

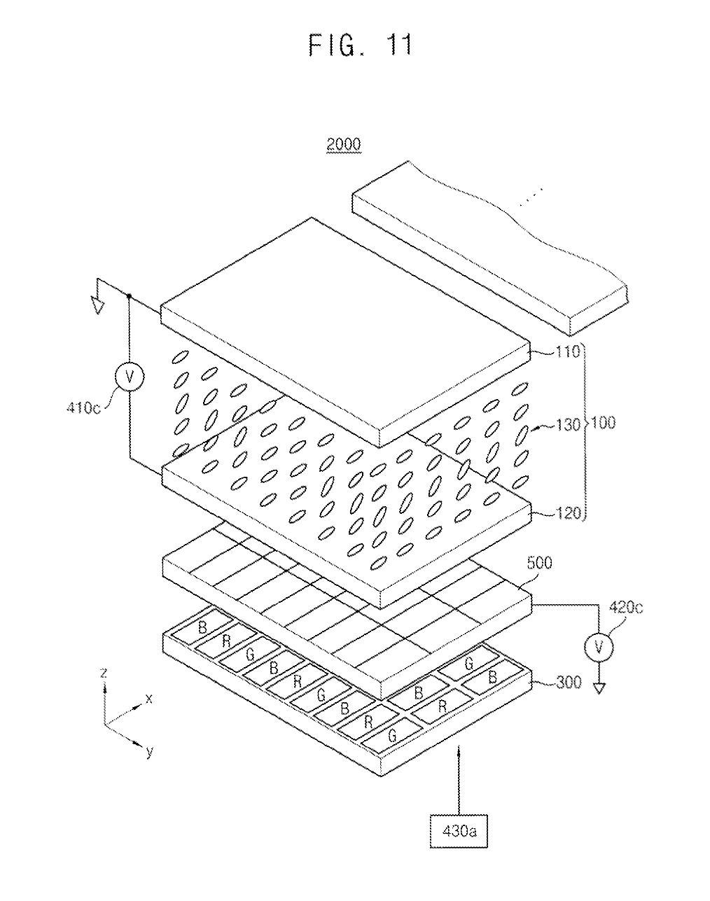

The electronically controllable LCL 100 may include an upper substrate 110, a lower substrate 120 in opposition to the upper substrate 110 and a liquid crystal material layer 130 interposed between the upper substrate 110 and the lower substrate 120. In one embodiment, the illustrated one exemplary voltage driver 410a actually represents a plurality of different voltage drivers coupled to different subsections of lower substrate 120 where the different voltage drivers represented by (410a) are electronically-controlled by an appropriate central controller (not shown) and the different voltage drivers can be operated so as to cause the electronically-controllable LCL 100 to function as an elongated convex one of a plurality of electronically-controllable lenticular lenses. (See briefly FIG. 10 where 700 is a lenticular lens of an alternate embodiment.)

More particularly, and as seen in FIG. 2A, the liquid crystal lens (LCL) 100 may include an upper transparent electrode 140 formed (e.g., of ITO or IZO) on the upper transparent substrate 110 and a plurality of lower transparent electrodes 150 opposite to the upper electrode 140. The upper electrode 140 may be formed on the upper substrate 110 in a flat plate shape, and the lower electrodes 150 may be formed on the lower substrate 120 as having parallel striped shapes that are elongated for example in the direction of the Y axis.

When a voltage is applied as between the upper electrode 140 and the lower electrodes 150, a corresponding electric field may be generated to pass vertically through the liquid crystal layer 130 formed between the upper (common) electrode 140 and the lower individual electrodes 150. The magnitude of the applied voltage (e.g., V1) as between the lower electrode 150 and the common electrode 140 may determine an amount of orientation changing force applied to liquid crystal molecules positioned in the vertical line (not shown) that hypothetically exists between the voltage-driven lower individual electrode 150 and the upper (or common) electrode 140. A refractive index (n) associated with that hypothetical vertical line (not shown) may change as a function of the applied voltage.

Furthermore, as shown in FIG. 2A, a plurality of symmetrically paired lower electrodes among the lower electrodes 150 may be formed to be symmetrically disposed relative to a central vertical line of the one lens shown in FIG. 2A so that the symmetrically paired lower electrodes 150 are both driven by a same drive voltage relative to the common electrode 140. When respective different voltages (V1, V2, V3, . . . Vn) are applied to the lower electrodes pairs, alignment directions of liquid crystal molecules in the liquid crystal application layer 130 may be controlled differently from each other in correspondence with the voltages applied as between the respective lower electrodes and the common electrode 140. Moreover, the lower electrode pairs are symmetrically formed, so that an alignment direction of the liquid crystal molecules may be symmetrically controlled by provision of a single drive voltage (e.g., V3) to each pair.

In one embodiment, the voltages applied to the lower electrode pairs increase as the driven electrodes become positioned closer and closer to an edge portion of the lower electrodes array of the given one LCL 100. Thus, the liquid crystal molecules disposed at an edge portion of the lower electrodes array 150 may be more vertically aligned with respect to the lower substrate 120 while those in the center are more horizontally aligned.

In accordance with the different voltages applied to the lower electrode pairs, the liquid crystal molecules disposed at a center portion of the lower electrodes 150 may be substantially more horizontally aligned with respect to the lower substrate 120, and the liquid crystal molecules disposed at an edge portion of the lower electrodes 150 may be substantially more vertically aligned with respect to the lower substrate 120.

The orientation angles of the liquid crystal molecules correlate to corresponding effective refractive indices (e.g., n1, n2, etc.) experienced by light rays passing vertically through the respective regions of the electronically controllable LCL 100. Accordingly, the LCL 100 may be operated as a variable graded index (GRIN) lens or a GRIN Fresnel lens having a distribution of refractive indices such as shown in the index (n) versus position and voltage graph of FIG. 2B.

The electronically controllable polarization switchable panel section 200 of FIG. 1 is disposed between the LCL 100 and the display panel 300 and is activated or deactivated by a respective control voltage source 420a. In one embodiment, the polarization switch panel 200 includes a plurality of segments S1, S2, . . . Sn (wherein, ‘n’ is a natural number). The segments S1, S2, . . . , Sn extend parallel to gate lines or image rows of the flat panel display 300 and the segments S1, etc. are sequentially driven in a scan direction in synchronizing with loading of new image data into rows of the two-dimensional (2D) image area or three-dimensional (3D) image area as provided on the display panel 300.

The polarization switchable panel section 200 may be selectively driven into a 2D image supporting mode or a 3D image supporting mode in correspondence to image data provided to the display panel 300 by a data source 430a. The image data provided to the display panel 300 is converted into optical signals that are output by 300 for post-processing by the polarization switchable panel section 200 in accordance with the first polarization mode or the second polarization mode. For example, the polarization switch panel 200 may be operated in the first polarization mode in which light rays belonging to a 2D image are polarized by the panel 200 according to a first polarization axis (not shown), and may be operated in the second polarization mode in which light rays belonging to a 3D image are differently polarized by the panel 200 according to a second different polarization axis (not shown). The first polarization axis and the second polarization axis may have a λ/2 phase delay difference defined between them where λ is a wavelength of a central color (e.g., green) provided by display panel 300.

When a 2D image is provided from the display panel 300, the polarization switch panel 200 receives a voltage from portion 420a of a polarization switch panel controller (not shown, see 420 of FIG. 3) and it alters light rays of the 2D image according to a first polarizing change defined by the first polarization axis. When a 3D image is provided from the display panel 300, the same polarization switch panel section 200 is driven by a corresponding voltage provided from the driving circuit part 420a and it alters the light rays of the 3D image according to a second polarizing change defined by the second polarization axis. Thus, the polarization switch panel 200 provides the LCL 100 with either first polarized light or second polarized light depending on how the corresponding segment of the polarization switching panel is driven.

The display panel 300 is disposed below the polarization switch panel 200. The display panel 300 receives divided image data signals from the data source 430a and these cause the display panel section 300 to provide the polarization switch panel section 200 with optical image signals corresponding to the divided image data electronic signals supplied by data source 430a.

Referring to FIG. 3, the driving circuit part 400 includes a liquid crystal lens controller 410, a polarization switch panel controller 420 and a display panel controller 430, where operations of the various controllers 410, 420 and 430 may be coordinated by a central control unit (not shown) such as a CPU.

The liquid crystal lens controller 410 applies a common voltage level to the upper electrode 140 and respective lens-defining drive voltages to the lower electrodes 150 of the LCL 100 to thereby control respective alignments of liquid crystal molecules interposed between the upper electrode 140 and the respective lower electrode 150 and to thereby electronically control the effective refractive index in each vertical section of liquid crystal molecules that overlies a corresponding lower electrode 150.

For example, the liquid crystal lens controller 410 may partially control an alignment of the liquid crystal molecules by providing the upper electrode 140 with a common voltage VCOM and the lower electrode 150 with a plurality of voltages V1, V2, V3, . . . , Vn divided into a plurality of predetermined levels that provide corresponding predetermined magnitudes of refractive index (n1, n2, etc.).

The display panel controller 430 includes a data partitioning (dividing) part 431, a section scaler 432 and a timing control part 433. The data partitioning (dividing) part 431 receives a frame's worth of image data from an external apparatus (not shown) and partitions it according to different kinds of image types that may be included within the frame. In one example, the frame image data includes a 2D frame image data portion and a 3D frame image data portion. The data division part 431 accordingly determines which is which and divides (partitions) the frame image data into the 2D frame image data portion and the 3D frame image data portion and identifies which is which. The data division part 431 also provides the image scaler 432 with the 2D frame image data portion and the 3D frame image data portion and instructions on how to dimensionally scale each portion.

The scaler 432 generates first frame image data including the 2D image data portion and a first black image remainder data based on a resolution format of the display panel 300. For example, the scaler 432 adds the first black image data to the 2D image data to generate the 2D frame image data. Further, the scaler 432 generates a 3D frame image data including the 3D image data and a second black image remainder data based on a resolution format of the display panel 300. For example, the scaler 432 adds the second black image data to the 3D image data to generate the 3D frame image data. In this embodiment, the 2D image data of the 2D frame image data and the second black image data of the 3D frame image data are adjusted, so that the 2D image data and the second black image data may be alternately displayed on an identical area. The images may be added temporally by the over-time image integrating characteristics of the human visual system. Furthermore, the first black image data of the 2D frame image data and the 3D image data of the 3D frame image data are adjusted, so that the first black image data and the 3D image data may be displayed on an identical area.

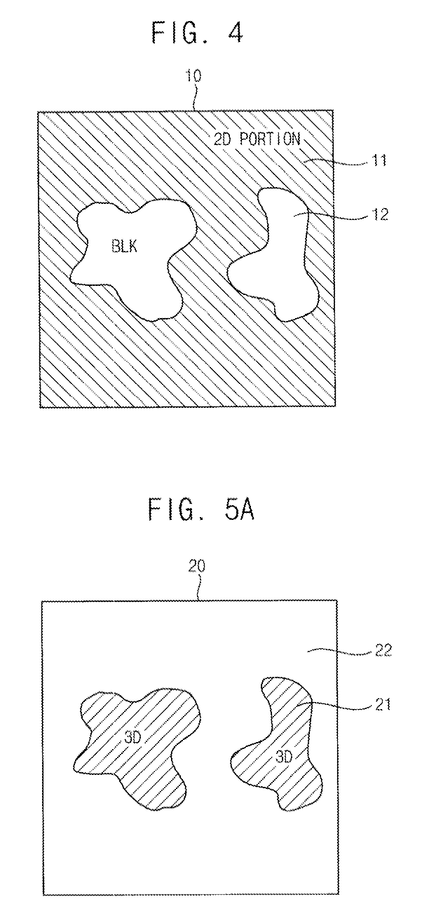

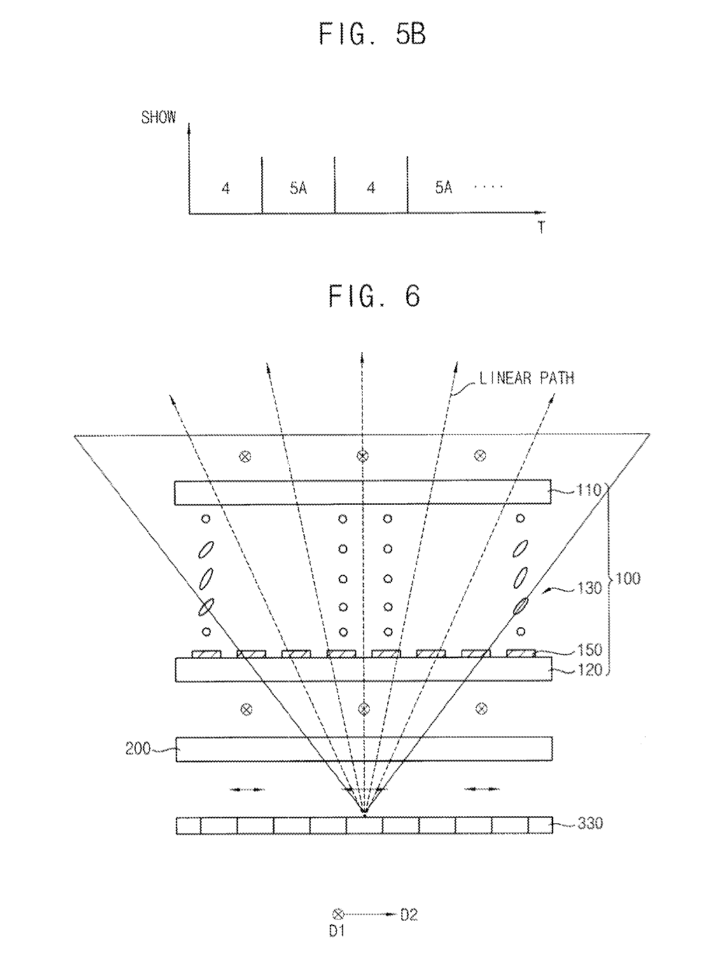

FIG. 4 is an image schematically showing an example of a 2D frame image. FIG. 5 is an image schematically showing an example of a 3D frame image.

Referring to FIG. 4, the 2D frame image 10 may include first black image areas (12) structured for displaying black image areas 12 within an encompassing area which a 2D image 11 will be displayed. That is, a hatched area in FIG. 4 may represent a 2D image area 11 displaying the 2D image, and the remaining area 12 excluding the 2D image area 11 is an area in which the first black image is displayed. With aid of over-time image integration, the remaining area 12 will be caused to appear to display a 3D image.

Referring to FIG. 5A, the 3D frame image may include a second black image for displaying a black image in accordance with an area 22, where the second black image area 22 coincides with the areas in which the 2D image 11 of FIG. 4 will be displayed. That is, a hatched area may represent a 3D image area 21 displaying the 3D image, and the remaining area 22 excluding the 3D image area 21 is an area in which the second black image is displayed. Referring to FIG. 5B, a timing diagram is shown for how the 2D and 3D display modes of FIGS. 4 and 5A may be alternated over time

More specifically, and referring again to FIG. 3, the timing control part 433 is operated in a high frequency to alternately provide the display panel 300 with the 2D image data DATA1 and the 3D image data DATA2. For example, the high frequency may be about 120 Hz or about 240 Hz in terms of frames per second.

FIG. 6 is a cross-sectional view schematically showing how polarization of light rays of a 2D image are transformed when the first polarization mode of the polarization switch panel 200 of FIG. 1 is activated.

Referring to FIGS. 4 and 6, the display panel controller 433 of the driving circuit part 400 provides the display panel 300 with the 2D image. The polarization switch panel controller 432 turns on the polarization switch panel 200 in synchronization with output of the 2D optical image. Thus, the 2D image of the 2D frame image 10 that is provided from the display panel 300 to the polarization switch panel 200 is firstly polarized by a first polarization axis having the first direction Dl (perpendicular to the drawing page) to be transmitted. That is, the 2D image is not refracted according to a lenticular lens effect with respect to liquid crystal molecules of the LCL 100 because the light rays are pre-polarized by switch panel section 200 so as not to be affected by the lens section 100. Thus, the light rays of the 2D image are projected outwardly in a substantially all linear fashion and they are thus displayed without any substantial variation of light paths by the LCL 100. It is as if the LCL section 100 were not present. However, the first black image of the 2D frame image 10 may block light from being provided through the polarization switch panel 200, so that a corresponding black image may be displayed on an area 12 excluding an area 11 on which the 2D image is displayed.

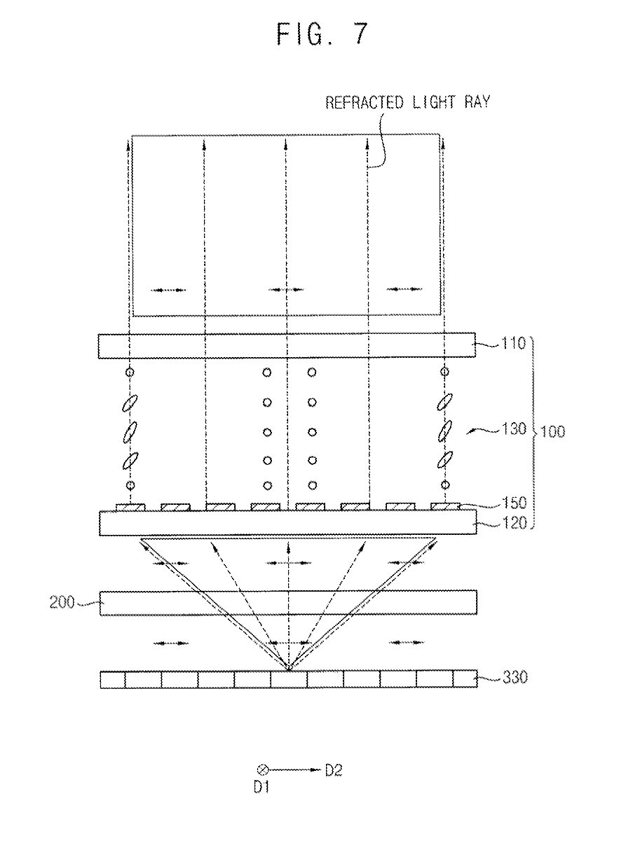

FIG. 7 is a cross-sectional view schematically showing a 3D image display mode in accordance with when a second polarization mode of the polarization switch panel section 200 of FIG. 1 is activated.

Referring to FIGS. 5 and 7, the display panel controller 433 of the driving circuit part 400 provides the display panel 300 with the 3D image. The polarization switch panel controller 432 turns off the polarization switch panel 200 in synchronization with presentation of the 3D image. Thus, a 3D image of the 3D frame image 20 provided from the display panel 300 to the polarization switch panel 200 is secondly polarized by the second polarization axis having a second direction D2 (orthogonal to D1) to thereby enhance refraction effects provided by the electronically controllable LCL 100. That is, the polarized light rays passed into the LCL 100 this time are affected by the different refractive indices and in the case where the electronically controllable LCL 100 is being operated as a lenticular lens of appropriate effective convex curvature or as other appropriate lens when in the 3D mode, then the light rays of the 3D image which are now secondly polarized according to direction D2 will be affected by the liquid crystal lens section 100 and the light rays will be bent according to the respective gradients of refractive indices provided by the liquid crystal lens section 100. FIG. 7 shows the case of a simple convex lens effect. However, the second black image of the 3D frame image 20 may block light provided to the polarization switch panel 200, so that a black image may be displayed on an area 22 excluding an area 21 on which the 3D image is displayed.

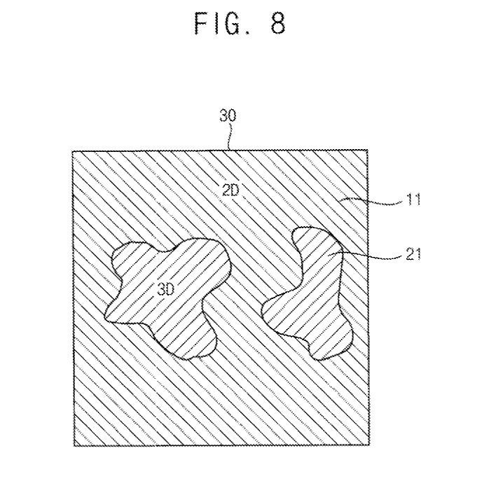

FIG. 8 is a schematically shown example of a combined mono/stereoscopic image 30 wherein the 2D non-black image portion 11 of FIG. 4 and the 3D non-black image portion 21 of FIG. 5A are perceived to be added together by the temporal image integrating characteristics of the human visual system due to the modes of FIGS. 4 and 5A being alternatingly driven in a high speed.

Still referring to FIG. 8, the 2D image portion 11 of FIG. 4 and the 3D image portion 21 of FIG. 5A appear to be simultaneously displayed on one screen. The display panel 300 alternately provides to the polarization switch panel 200 the optical signals of the 2D image data and the 3D image data in a frequency of about 120 Hz or higher (e.g., in a frequency of about 240 Hz), and the polarization switch panel 200 is alternately driven into its 2D-processing, first polarization mode and into its 3D-processing, second polarization mode. Thus, viewer may simultaneously perceive the 2D non-black image portion 11 of FIG. 4 and the 3D non-black image portion 21 of FIG. 5A as co-existing in a same screen area.

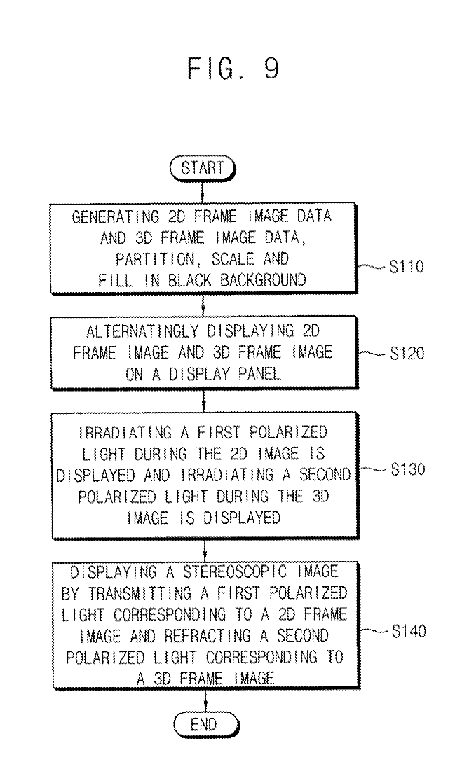

FIG. 9 is a flowchart showing a method of displaying a stereoscopic image according to the above described Embodiment 1 of the present disclosure.

In step S110 of FIG. 9, 2D image data and 3D image data are generated by appropriate image data generating means (e.g., using a computer, not shown) in preparation for alternatingly flashing partitioned frames and black-backgrounded frames like those of FIGS. 4 and 5A. Step S110 is also understood to include the image partitioning, scaling and black-background fill in operations performed for example by modules 431 and 432 of FIG. 3. Once, image partitioning, scaling and black-background fill in operations are complete, the resultant 2D image data signals include the 2D image data and the first black background image data, and the resultant 3D image data signals include the 3D image data and second black background image data.

Then, a 2D frame image and a 3D image frame image are alternately displayed by the display panel (step S120). The displayed 2D frame image corresponds to the 2D frame image data signals, and the displayed 3D frame image corresponds to the 3D frame image data signals.

As the 2D frame image and 3D frame image are being alternatingly displayed, the polarization switch panel 200 is being alternatingly switched in synchronism with the flashed images between its 2D image-processing mode and its 3D image-processing mode respectively (step S130).

The repolarized or not re-polarized light rays output from the polarization switch panel 200 are then transmitted through the electronically controllable liquid crystal lens (LCL) 100. In the 3D image-processing mode, the LCL 100 refracts the second polarized light corresponding to the 3D image to thereby display a corresponding portion of a stereoscopic image. In the 2D image-processing mode, the LCL 100 does not refract the first polarized light rays sent to it, which light rays correspond to the 2D image (step S140).

An advantage of having electronically controllable liquid crystal lens (LCL) 100 is that the focal point of the lenticular lenses can be varied to correspond to the sitting position of the viewer. However, if that advantage is deemed unnecessary, a simple embodiment can be used. FIG. 10 is a perspective view schematically illustrating another example of a mono/stereoscopic image display apparatus according to the present disclosure.

The illustrated mono/stereoscopic image display apparatus 3000 according to the second embodiment may employ a fixed shape lenticular lens 700 such as shown in FIG. 10 to replace of the electronically controllable liquid crystal lens (LCL) 100 of FIG. 1 in each position where such lenticular lens 700 is called for by the display design.

Thus, in the fixed lens mono/stereoscopic image display apparatus 3000 according to the second embodiment, the polarization switch panel 200 again is alternately driven into its 2D image data processing mode (first polarization mode) and its 2D image data processing mode (second polarization mode) in synchronism with the alternatingly flashed 2D and 3D image frames, so that corresponding 2D images with black backgrounds and 3D images with black backgrounds are rapidly and alternatingly flashed to the viewer to thereby create the perception of 2D and 3D image portions being simultaneously displayed on one continuous screen area.

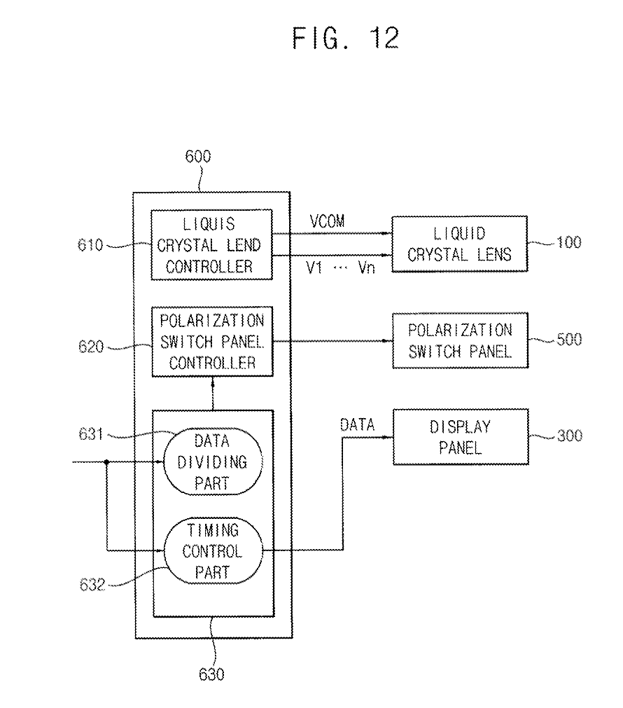

FIG. 11 is a perspective view schematically illustrating a mono/stereoscopic image display apparatus 2000 according to a third Embodiment of the present disclosure. FIG. 12 is a block diagram schematically illustrating a mono/stereoscopic image display apparatus 2000 according to the present embodiment.

Referring to FIGS. 11 and 12, the mono/stereoscopic image display apparatus 2000 according to the present embodiment includes a liquid crystal lens (LCL) 100, a polarization switch panel 500 and a display panel 300. The stereoscopic image display apparatus 2000 further includes a driving circuit part 600.

The polarization switch panel 500 is disposed between the LCL 100 and the display panel 300. The polarization switch panel 500 includes a plurality of pixel sections corresponding to pixels or other subdivisions of a matrix of pixels provided on the display panel 300. Thus, the polarization switch panel 500 may be sequentially driven in synchronism the gate lines (not shown) and data lines (not shown) of the display panel 300 as image data for respective 2D and 3D image portions are loaded into the respective pixels for display thereby.

Moreover, the pixel sections of the polarization switch panel 500 may be divided in a same time instant into those defining a first polarization area having a first polarization axis and those defining a second polarization area having a second polarization axis. The first and second polarization areas may be optionally set. For one example, predetermined subareas of the polarization switch panel 500 may be firstly polarized in the first polarization axis. For another example, predetermined subareas of the polarization switch panel 500 may be secondly polarized in the second polarization axis. The first polarization axis and the second polarization axis may have a λ/2 phase delay difference from each other.

When the 2D frame image is provided to the display panel 300, the polarization switch panel 500 receives voltages from the polarization switch panel controller (sent to its respective pixel sections) to alter the image into the first polarized light with respect to the first polarization axis at the first polarization area. When the 3D frame image is provided to the display panel 300, the polarization switch panel 500 receives voltages from the driving circuit part 400 to alter the image into the second polarized light with respect to the second polarization axis at the second polarization area. Thus, the polarization switch panel 500 simultaneously provides the LCL 100 with the first polarized light and the second polarized light.

The display panel 300 is disposed below the polarization switch panel 500. The display panel 300 receives the frame image from the driving circuit part 600 to provide the polarization switch panel 500 with frame images that are synchronized to the switched modes of the different areas of the polarization switch panel 500.

The driving circuit part 600 includes a liquid crystal lens controller 610, a polarization switch panel controller 620 and a display panel controller 630.

The liquid crystal lens controller 610 applies a voltage to an upper electrode 140 and a lower electrode 150 of the LCL 100 to control alignment of liquid crystal molecules interposed between the upper electrode 140 and the lower electrode 150.

For example, the liquid crystal lens controller 610 provides the upper electrode 140 with a common voltage VCOM and provides the lower electrode 150 with voltages V1, . . . , Vn that are divided into plural levels, so that alignment of the liquid crystal molecules may be controlled.

The display panel controller 630 includes a data dividing (partitioning) part 631 and a timing control part 632. The data dividing part 631 and the timing control part 632 receive an image data from an external device (not shown). The data dividing part 631 divides the image data into a first image data and a second image data in synchronism with operations of the polarization switch panel 500. The first image data corresponds to the first polarization area of the polarization switch panel 500, and the second image data corresponds to the second polarization area of the polarization switch panel 500.

The timing control part 632 is driven in a high frequency to provide the display panel 300 with the first and second image data.

The polarization switch panel controller 620 is driven into the first polarization mode in areas thereof in which the 2D image data is to be firstly polarized in accordance with a control provided by the data dividing part 631. Moreover, the polarization switch panel controller 620 is driven in the second polarization mode in areas thereof in which the 3D image data is to be secondly polarized in accordance with control provided by the data dividing part 631.

The mono/stereoscopic image display apparatus 2000 according to the present embodiment may alternatively employ a fixed lenticular lens such as 700 of FIG. 9 in place of LCL 100.

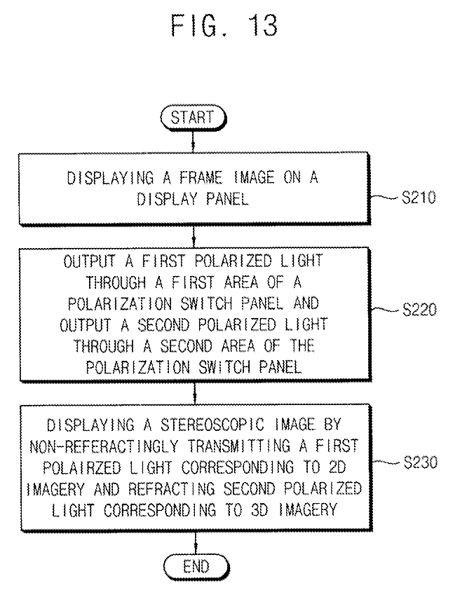

FIG. 13 is a flowchart showing a method of displaying a mono/stereoscopic image in accordance with the third embodiment.

Referring to FIG. 13, a frame image including a 2D image and a 3D image is displayed on the display panel (step S210).

A first area of the polarization switch panel corresponding to the 2D image emits the first polarized light, and a second area of the polarization switch panel corresponding to the 3D image emits the second polarized light (step S220).

The lens transmits, without substantially refracting it, the first polarized light corresponding to the 2D image, and the lens refracts the second polarized light corresponding to the 3D image to thereby display a mono/stereoscopic image (step S230).

Thus, user may simultaneously view a 2D image driven in the first polarization mode and a 3D image driven in the second polarization mode on one screen.

Thus, in a mono/stereoscopic image display apparatus 2000 according to the present embodiment, the polarization switch panel 500 differently polarizes the frame image provided from the display panel 300 in different areas so that the frame image that is firstly polarized by the first polarization area and the frame image that is secondly polarized by the second polarization area may be simultaneously transmitted through the LCL 100 so that a mono/stereoscopic image may be simultaneously displayed on one screen.

As described above, according to embodiments of the present disclosure, the polarization switch panel is operated in a first polarization mode when and/or where light rays of a 2D image portion are being provided from the display panel. The polarization switch panel is operated in the second polarization mode when and/or where light rays of a 3D image portion are being provided from the display panel. Accordingly, 2D imagery and 3D imagery may be displayed alone or together from arbitrarily chosen parts of one screen.

Moreover, the polarization switch panel includes a first area which is operated in the first polarization mode corresponding to the 2D image and a second area which is operated in the second polarization mode corresponding to the 3D image, so that the 2D image and the 3D image may be displayed on one screen.

Therefore, the mono/stereoscopic image display apparatus which employs the polarization switch panels may be applied to various industrial fields requiring an interactive 2D/3D system.

The foregoing is illustrative of the present teachings and is not to be construed as limiting thereof. Although a few example embodiments in accordance with the present teachings have been described, those skilled in the pertinent art will readily appreciate from the foregoing that many modifications are possible in the example embodiments without materially departing from the teachings. Accordingly, all such modifications are intended to be included within the scope of the present teachings. In the claims, means-plus-function clauses are intended to cover the corresponding structures described herein as performing the recited function and not only structural equivalents but also functionally equivalent structures. Therefore, it is to be understood that the foregoing is illustrative of the present disclosure of invention and is not to be construed as limited to the specific example embodiments disclosed herein.

What is claimed is:

1. A method of selectively displaying one or both of stereoscopic imagery and monoscopic imagery from a same display apparatus, the method comprising:
rendering a two-dimensional (2D) image data portion on a respective first black-filled background;
rendering a three-dimensional (3D) image data portion on a respective second black-filled background;
forming a 2D image frame containing the rendered 2D image data portion with its respective first black-filled background;
forming a 3D image frame containing the rendered 3D image data portion with its respective second black-filled background;
alternatingly displaying the formed 2D image frame and the formed 3D image frame on a display panel;
imparting a first polarization effect to light rays belonging to the displayed 2D image frame;
imparting a different second polarization effect to light rays belonging to the displayed 3D image frame; and
transmitting the light rays having the first polarization effect imparted to them and the second polarization effect imparted to them through a polarization sensitive refracting layer that refracts light rays differently depending on whether the first polarization effect or the second polarization effect is imparted to the light rays passing through the polarization sensitive refracting layer.

2. A method of selectively displaying a stereoscopic image, the method comprising:
displaying first flat imagery corresponding to a two-dimensional (2D) image during a first time duration and/or from a first randomly selectable area of a flat panel display;
displaying second flat imagery corresponding to a three-dimensional (3D) image during a second time duration and/or from a second randomly selectable other area of the flat panel display;
imparting a first polarization effect to light rays belonging to the displayed first flat imagery of the 2D image;
imparting a different second polarization effect to light rays belonging to the displayed second flat imagery of the 3D image; and
transmitting the light rays having the first polarization effect imparted to them and the light rays having the second polarization effect imparted to them through a polarization sensitive lens layer.

3. An image display apparatus comprising:
a display panel capable of displaying two-dimensional images;
a driving circuit part having an image data processing part that is structured to receive input frame image data signals comprising a first image data portion representing two-dimensional (2D) imagery and a second image data portion representing three-dimensional (3D) imagery, the driving circuit part being coupled to the display panel to provide the display panel with processed frame image data signals derived from the received input frame image data signals;
a polarization switch panel disposed above the display panel, the polarization switch panel being selectively switchable into a first polarization mode whereby it can impart a corresponding first polarization effect to light rays passing through one or more parts of the polarization switch panel that are in said first polarization mode and the polarization switch panel being selectively switchable into a second polarization mode whereby it can impart a corresponding different and second polarization effect to light rays passing through one or more parts of the polarization switch panel that are in said second polarization mode; and
a polarization sensitive lens disposed above the polarization switch panel, the lens applying different refraction actions to light rays passing there through depending on whether the light rays have the first or the second polarization effect imparted to the passing-through light rays.

4. The image display apparatus of claim 3 wherein:
the image data processing part of the driving circuit part is structured to generate 2D image frame data signals representing a corresponding 2D image and a first black-filled background for the corresponding 2D image;
the image data processing part is further structured to generate 3D image frame data signals representing a corresponding 3D image and a second black-filled background for the corresponding 3D image.

5. The image display apparatus of claim 4, wherein:
the polarization switch panel is controlled so as to be synchronously switched into the first polarization mode when and/or where imagery of the 2D image frame data signals is being displayed on the display panel, and
the polarization switch panel is controlled so as to be synchronously switched into the second polarization mode when and/or where imagery of the 3D image data signals is being displayed on the display panel.

6. The image display apparatus of claim 4, wherein the image data processing part of the driving circuit part comprises:
a data dividing part structured to divide received frame image data signals and form from the divided signals, the 2D image frame data signals and the 3D image frame data signals;
a scaler structured to optionally resize and/or re-position the 2D imagery in its respective first black-filled background and structured to optionally resize and/or re-position the 3D imagery in its respective second black-filled background; and
wherein the driving circuit part further comprises a timing control part structured to alternatingly output the 2D frame image data and the 3D frame image data at a frame interlacing frequency that is higher than a display frequency of the originally received image data.

7. The image display apparatus of claim 6, wherein the frame interlacing frequency is about 120 Hz or about 240 Hz.

8. The image display apparatus of claim 3, wherein the driving circuit part drives a first area of the polarization switch panel into the first polarization mode in correspondence with 2D imagery displayed by the display panel for that first area, and drives a second area of the polarization switch panel into the second polarization mode in correspondence with 3D imagery displayed by the display panel for that second area.

9. The image display apparatus of claim 8, wherein the polarization switch panel transmits a first polarization light of the first area and transmits a second polarization light of the second area.

10. The image display apparatus of claim 8, wherein the driving circuit part comprises:
a data dividing part dividing the frame image data received in a first frame frequency into the 2D image data and the 3D image data; and
a timing control part outputting the frame image data to the display panel.

11. The image display apparatus of claim 8, wherein the driving circuit part further comprises a polarization panel controller structured to drive a corresponding part or all of the polarization switch panel into the first polarization mode in response to 2D imagery being displayed under that corresponding part or whole of the polarization switch panel and structured to drive a corresponding part or all of the polarization switch panel into the second polarization mode in response to 3D imagery being displayed under that corresponding part or whole of the polarization switch panel.

12. The image display apparatus of claim 3, wherein a first polarization axis of light transformed by the first polarization mode is substantially perpendicular to a second polarization axis of light transformed by the second polarization mode.
